(19) United States
(12) Patent Application Publication
(10) Pub. No.: US 2011/0146586 A1
(43) Pub. Date: Jun. 23, 2011

(54) Long lasting dog toy

(76) Inventor: Michael A. Turner, Peoria, AZ (US)

(21) Appl. No.: 12/928,450

(22) Filed: Dec. 10, 2010

Related U.S. Application Data
(60) Provisional application No. 61/283,934, filed on Dec. 10, 2009.

(51) Int. Cl. A01K 29/00

(52) U.S. Cl. 119/709

(57) ABSTRACT

The Long Lasting Dog Toy is a line of specially designed dog toys, each featuring reinforced Kevlar™ and Teflon™ material designed to withstand excessive wear and tear. The Long Lasting Dog Toy features a lightweight, yet durable hardened carbon fiber outer shell, with a textured nylon or, in other embodiments, a comparable coating designed to provide a pleasing texture to the animal. Most notably, the interior of the Long Lasting Dog Toy is comprised of alternating layers of reinforced Kevlar and Teflon, in the center of which is a porous rubber core designed to facilitate bounce. The Long Lasting Dog Toy is produced in a myriad of colors and designs.

### CLAIM OF PRIORITY

This patent application claims priority under 35 USC 119 (e) (1) from U.S. Provisional Patent Application Ser. No. 61/283,934 filed Dec. 10, 2009, of common inventorship herewith entitled, “Long Lasting Dog Toy.”

### FIELD OF THE INVENTION

The present invention pertains to the field of pet toys, and more specifically to the field of durable dog toys.

### BACKGROUND OF THE INVENTION

The prior art has put forth several designs for safe durable dog toys. Among these are:

U.S. Pat. No. 6,615,766 to Jon K. Curry describes a method and apparatus for reducing the risk that a thrown toy will injure an animal. The apparatus consists of a toy which when thrown bounces erratically, which compressively elastically deform, which includes a soft fabric outer surface that compresses to absorb blows, and which can withstand being bitten or chewed by a dog.

U.S. Pat. No. 6,918,355 to Margherita Jessie Arvanites describes a durable pet toy has a bullet resistant fabric therein, with a flexible material or a noise making material contained within the fabric, and a cover over the outer or surface portion of the bullet resistant fabric.

U.S. Pat. No. 7,201,117 to Sharon A. Ritchey and Jon K. Curry describes a method and apparatus for reducing the risk that a thrown toy will injure an animal. The apparatus consists of a toy which when thrown bounces erratically, which compressively elastically deforms, which includes a soft fabric outer surface that compresses to absorb blows, and which can withstand being bitten or chewed by a dog.

None of these prior art references describe the present invention.

### SUMMARY OF THE INVENTION

It is an object of the present invention to provide a durable long lasting dog toy.

### BRIEF DESCRIPTION OF THE DRAWINGS

FIG. 1 shows a front perspective view of two embodiments of the device of the present invention.

FIG. 2 is a cross section perspective view of the device of the present invention.

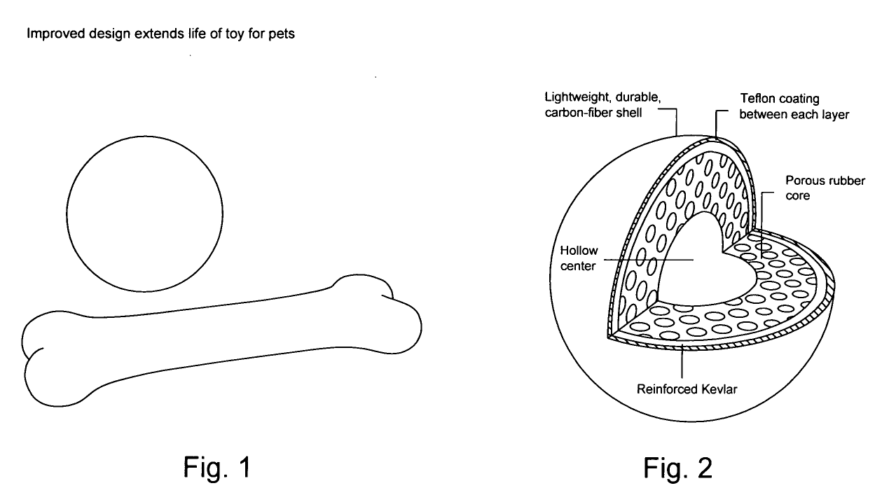

### DETAILED DESCRIPTION OF THE INVENTION

Four in ten households include a family dog. Why do so many people own dogs? The answer to that question is simple; dogs provide unconditional love, companionship and unmatched loyalty to their owners. Known as “man's best friend”, dogs offer protection and are faithful and constant friends. For many owners, a favorite end to a hectic day is spent curled up on a sofa or chair, with a beloved dog nestled nearby. Because dogs are more often considered a member of the family, as opposed to merely a pet, most owners provide adequate shelter, as well as a healthy diet for their animals. In addition, playful interaction between pet and owner is an essential tool in cementing the bond animals and humans share. From tossing a ball for the dog to retrieve or wrestling with a twine rope, these activities provide pets with amusement and warm the hearts of owners when they see their beloved companions filled with such delight. Beneficial to an animal's spirit, playing with their owners also affords pets much needed exercise and energy release. Perhaps the only drawback associated with pet toys has to do with their longevity. Specifically, pet toys are typically manufactured as stuffed dolls or rubber or plastic chew toys. Unfortunately, in their excitement to play, a dog can completely destroy a toy in little time. Creating a mess in one's house, bits and pieces of plastic and rubber can sully carpeting and in worse case scenarios, present choking hazards to the animal.

The present invention, hereinafter referred as the Long Lasting Dog Toy is a line of specially designed dog toys, each featuring reinforced Kevlar and Teflon material designed to withstand excessive wear and tear. The Long Lasting Dog Toy features a lightweight, yet durable hardened carbon fiber outer shell, with a textured nylon or, in other embodiments, a comparable coating designed to provide a pleasing texture to the animal. Most notably, the interior of the Long Lasting Dog Toy is comprised of alternating layers of reinforced Kevlar and Teflon, in the center of which is a porous rubber core designed to facilitate bounce. The Long Lasting Dog Toy is produced in a myriad of colors and designs.

Use and application of the Long Lasting Dog Toy is very simple and straightforward. First, the pet owner chooses one or more Long Lasting Dog Toys in the desired size and shape for play by their pet. By way of example, a baseball enthusiast may choose a Long Lasting Dog Toy baseball for his Great Dane. Alternately, a Long Lasting Dog Toy shaped like a bone offers a fun plaything for a Terrier pup. The user simply tosses the toy to their dog, or engages their animal in a free spirited game of catch, via the Long Lasting Dog Toy. Reinforced with Kevlar and Teflon, the Long Lasting Dog Toy withstands hours of continual play.

There are several significant benefits and advantages associated with this creative product invention. Foremost, the Long Lasting Dog Toy provides pets and their owners with a fun, interactive line of toys that they can enjoy together. Specially designed pet toys boasting an internally contained Kevlar and Teflon, the Long Lasting Dog Toy withstands hours of rough play, without cracking, breaking or otherwise deteriorating. As such, the Long Lasting Dog Toy is enjoyed for extended periods, without requiring repeated replacements. Boasting a sturdy design which withstands continued enjoyment by the animal, the Long Lasting Dog Toy is chewed without presenting the choking hazards associated with traditional dog toys. Further, because this product does not break down, the messes associated with traditional dog toys is effectively eliminated. In this manner, household pets are amused for hours, thus facilitating the exercise and energy release that is essential to their health and well-being. This attention-grabbing line of toys also serves to entertain dogs when left home alone, helping them not to feel so lonely and thereby possibly preventing them from tearing or ripping furniture and other valuables. In addition, pet owners surely delight in watching their companions scramble after the Long Lasting Dog Toy, as the animals' tenacious and frenzied attempts to retrieve the object would inspire laughter and merriment. Although designed specifically for dogs, the Long Lasting Dog Toy toys could also prove a favorite toy of any inquisitive feline, providing cat owners a new and innovative toy with which to entertain their pet. Made of durable, high quality materials and components, the Long Lasting Dog Toy withstands years of continued use.

An innovative product invention, the Long Lasting Dog Toy would offer an invaluable tool for pet and owner playtime. Encouraging a healthy body as well as spirit for the pet, this interactive device would provide both mental and physical stimulation. Affordably priced, the Long Lasting Dog Toy should be well received by the vast majority of dog owners, a very sizable market potential.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A durable long lasting dog toy, comprising reinforced Kevlar™ and Teflon™ material to withstand excessive wear and tear, further comprising a lightweight, yet durable hardened carbon fiber outer shell, with a textured nylon coating designed to provide a pleasing texture to the animal, wherein the interior of the long lasting dog toy is comprised of alternating layers of reinforced Kevlar and Teflon, surrounding a core comprised of porous rubber designed to facilitate bounce.

2. The dog toy of claim 1 in the shape of a ball.

3. The dog toy of claim 1 in the shape of a bone.

4. A long lasting dog toy comprising a hollow center, surrounded by porous rubber, which is surrounded by Teflon, which is surrounded by Kevlar, which is surrounded by Teflon, which is surrounded by an outer shell of lightweight, durable carbon-fiber.
